(19) United States
(12) Patent Application Publication
(10) Pub. No.: US 2001/0024960 A1
(43) Pub. Date: Sep. 27, 2001

(54) Method of optimizing speech quality in a mobile radio system

(76) Inventor: Raphaelle Mauger, Versailles (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/810,216

(22) Filed: Mar. 19, 2001

(30) Foreign Application Priority Data
Mar. 20, 2000 (FR) 00 03 520

(51) Int. Cl. H04M 1/00

(52) U.S. Cl. 455/552; 455/553

(57) ABSTRACT

A method is disclosed of optimizing speech quality in a mobile radio system by using if possible a tandem free operation mode for a mobile-to-mobile call. Because the tandem free operation mode is impossible in the case of a coding mode that is unauthorized for that operation mode, instead of using a tandem operation mode in this case, the tandem free operation mode is used, if possible, with an authorized coding mode, provided that the authorized coding mode is supported.

### BACKGROUND OF THE INVENTION

1. Field of the Invention

The present invention relates generally to mobile radio systems.

The present invention relates more particularly to speech services and to the techniques employed in mobile radio systems to optimize the quality of service.

2. Description of the Prior Art

Generally speaking, various coding (or source coding) modes can be used to transmit speech at the radio interface, corresponding to different compromises between speech quality and the quantity of radio resources needed to transmit the speech. Accordingly, in the Global System For Mobile communications (GSM) the following coding modes can be used, among others:

a full rate (FR) mode corresponding to a bit rate of 13 kbit/s,

an enhanced full rate (EFR) mode corresponding to a bit rate of 12.2 kbit/s, and

a half rate (HR) mode corresponding to a bit rate of 5.6 kbit/s.

As a general rule, for a given mobile, the choice of a coding mode can be fixed or adaptive from all of the coding modes supported (i.e. supported by that mobile and by the entities of the system handling the call for that mobile, as will be assumed hereinafter).

A fixed choice of coding mode has the drawback that it is not possible to employ a better compromise between the instantaneous speech quality and the necessary quantity of radio resources, depending on the conditions encountered.

The adaptive choice of a coding mode avoids this drawback. In particular, in the adaptive multirate (AMR) coding mode, an instantaneous optimum combination of given source code and a given channel code is chosen depending on the transmission conditions encountered (channel coding provides protection against transmission errors by introducing some redundancy into the information transmitted; this is known in the art).

Equipment units known as transcoders are used to change between the coding mode selected in this way for transmission at the radio interface and a standard coding mode such as the pulse code modulation (PCM) mode generally used in cable networks and corresponding to a bit rate of 64 kbit/s. In the GSM, a transcoder is also known as a transcoder rate adapter unit (TRAU).

Although transcoding in this way is necessary for a call between a mobile terminal and a fixed terminal, it is not necessary for a call between two mobile terminals. In this case, to prevent unnecessary reduction of speech quality by subjecting the speech to two successive transcoding operations, a tandem free operation (TFO) mode is used, if possible. The TFO mode is specified in GSM Recommendations 02.53, 03.53 and 08.62 in particular.

As a general rule, establishing the TFO mode requires negotiation between like entities of the system handling the call for each of the mobiles concerned. Because the coding mode is generally selected independently for each of the mobiles, one aim of such negotiation is to select a common coding mode for the TFO mode, and therefore to change the coding mode for at least one of the mobiles, if necessary, i.e. if the coding mode initially selected for that mobile is different from the common coding mode selected for the TFO mode.

At present, the TFO mode cannot be used with the AMR mode, in particular because the AMR mode is adaptive, independently for each mobile, which would make the TFO mode relatively complex to implement. Accordingly, at present, if the coding mode selected for a mobile is the AMR mode, the only negotiation provided for is to establish the TFO mode between the system entity handling the call for that mobile and the like entity.

In this context, one particular object of the present invention is to optimize speech quality by attempting to obtain the benefit of the TFO mode whenever possible.

### SUMMARY OF THE INVENTION

The present invention therefore provides a method of optimizing speech quality in a mobile radio system by using if possible a tandem free operation mode for a mobile-to-mobile call, in which method, because the tandem free operation mode is impossible in the case of a coding mode that is unauthorized for that operation mode, instead of using a tandem operation mode in this case, the tandem free operation mode is used, if possible, with an authorized coding mode, provided that the authorized coding mode is supported.

According to another feature, if the tandem free operation mode is established after negotiation with the aim of selecting a common coding mode for that operation mode, and the negotiation was initiated on the basis of coding modes initially selected independently for each of the mobiles, and if the coding mode initially selected for at least one of the mobiles is an unauthorized coding mode, negotiation is initiated with the unauthorized coding mode for that mobile replaced by an authorized coding mode, provided that the authorized coding mode is supported.

According to another feature, if the coding modes on the basis of which the negotiation was initiated match they constitute the common coding mode for the tandem free operation mode.

According to another feature, if the coding modes on the basis of which the negotiation was initiated do not match a common coding mode for the tandem free operation mode is selected on the basis of lists of coding modes supported, for each of the mobiles, at least one of the lists not including any unauthorized coding mode.

According to another feature, the system is the GSM.

According to another feature, one unauthorized coding mode is an adaptive coding mode.

According to another feature, one adaptive coding mode is the AMR mode.

According to another feature, one authorized coding mode is the full rate mode.

According to another feature, one authorized coding mode is the enhanced full rate mode.

According to another feature, one authorized coding mode is the half rate mode.

The present invention also provides a mobile radio system, in which a tandem free operation mode is used if possible for a mobile-to-mobile call, and, if the tandem free operation mode is not possible in the case of a coding mode that is unauthorized for that operation mode, it includes means for, instead of using a tandem operation mode in this case, using the tandem free operation mode, if possible, with an authorized coding mode, provided that the authorized coding mode is supported.

Other objects and features of the present invention will become apparent on reading the following description, which is given with reference to the accompanying drawings.

### BRIEF DESCRIPTION OF THE DRAWINGS

FIG. 1 shows one example of a prior art method.

FIG. 2 shows one embodiment of a method according to the invention.

FIG. 3 shows another embodiment of a method according to the invention.

FIG. 4 shows a further embodiment of a method according to the invention.

### DETAILED DESCRIPTION OF THE PREFERRED EMBODIMENTS

As previously explained, in the case of a mobile-to-mobile call, the TFO mode avoids unnecessary reduction in speech quality by unnecessarily subjecting the speech to two successive transcoding operations. Consequently, if a new coding mode is selected for at least one of the mobiles, it is beneficial to use the TFO mode if possible.

Generally speaking, a new coding mode can be selected for a mobile either at the time a call is set up, i.e. at the time of initial allocation of radio resources to the mobile, or on the occasion of any subsequent change in the allocation of radio resources, for example in the event of either intra-cell or inter-cell handover.

The TFO mode is generally established following negotiation between like entities of the system handling the call for each of the mobiles with the aim of selecting a common coding mode for the TFO mode.

Generally speaking, the like entities can include one and/or the other of the following entities:

the base station subsystem (BSS) in respect of the functions associated with transmission at the radio interface (the BSS includes the base transceiver stations (BTS) and base station controllers (BSC)), and

the TRAU in respect of the transcoding function.

The negotiation can include the following steps:

a first signaling step during which the like entities communicate the coding modes initially selected independently for each of the mobiles,

a step in which it is determined if the coding modes initially selected match; if they do, they constitute the common coding mode for the TFO mode, and the TFO mode is then established with that coding mode; if they do not match (this situation is referred to as a “codec mismatch”), the following steps are executed:

a second signaling step during which the like entities communicate to each other a list of coding modes supported for each of the mobiles,

a codec mismatch resolution step during which it is determined if a coding mode is supported in common in the lists of coding modes supported (generally starting with the coding modes providing better speech quality); if there is a coding mode supported in common in the lists, that coding mode constitutes the common coding mode for the TFO mode, and the TFO mode is then established with that coding mode; if there is no coding mode supported in common in the lists, the TFO mode cannot be established and the mode of operation continues to be a tandem operation mode;

if the TFO mode can be established, a step during which a change of coding mode is effected for at least one of the mobiles if the coding mode initially selected for that mobile is different from the common coding mode selected for the TFO mode.

In what follows, the entity initiating the negotiation is referred to as the local entity A and the other entity is referred to as the remote entity B.

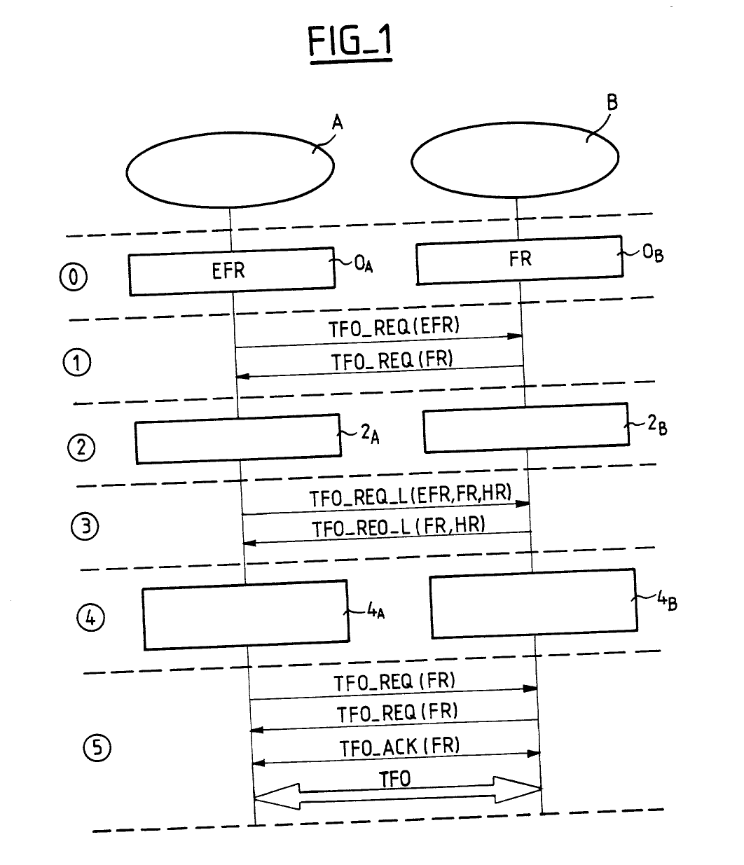

FIG. 1 shows one example of the various process steps outlined above. Consider by way of example the situation in which the coding mode initially selected for the mobile managed by the local entity A is the EFR mode and the coding mode initially selected for the mobile managed by the remote entity B is the FR mode, this initial coding mode selection corresponding to an initial step 0 (0_{A}, 0_{B}). Consider also by way of example the situation in which the set of coding modes EFR, FR and HR is supported for the mobile managed by the local entity A and the set of coding modes FR and HR is supported for the mobile managed by the remote entity B.

In FIG. 1, the negotiation includes:

a first signaling step 1 during which the local entity A transmits a message TFO_REQ (EFR) to the remote entity B and the remote entity B transmits a message TFO_REQ (FR) to the local entity A,

a step 2 (2_{A}, 2_{B}) during which each entity detects that the coding modes initially selected independently for each of the mobiles do not match,

a second signaling step 3 during which the local entity A transmits a message TFO_REQ_L (EFR, FR, HR) to the remote entity B and the remote entity B transmits a message TFO_REQ_L (FR, HR) to the local entity A,

a step 4 (4_{A}, 4_{B}) during which it is determined if a coding mode is supported in common in the lists of coding modes supported communicated in step 3; in this example, of the coding modes supported in common, the coding mode FR being that providing the best speech quality, it constitutes the common coding mode for the TFO mode and a change of coding mode is effected in step ⁴A, from the EFR mode to the FR mode, and

a step 5 during which the local entity A transmits a message TFO_REQ (FR) to the remote entity B, the remote entity B transmits a message TFO_REQ (FR) to the local entity A, the local and remote entities exchange messages TFO_ACK (FR), and then the local and remote entities exchange TFO frames.

As previously mentioned, at present the TFO mode is not possible in the case of the AMR coding mode referred to in this example. In particular, if the coding mode selected initially for a mobile managed by the local entity A is the AMR mode, no negotiation with a view to establishing the TFO mode is initiated by the local entity A.

This means that speech quality cannot be optimized.

A particular object of the present invention is to avoid this drawback.

In the method according to the invention, because the tandem free operation mode is not possible in the case of a coding mode that is referred to as unauthorized for that mode of operation, instead of using the tandem operation mode in this case, the tandem free operation mode is used, if possible, with an authorized coding mode, provided that the authorized coding mode is supported.

In particular, because the tandem free operation mode is established after negotiation aimed at selecting a common coding mode for that mode of operation, and such negotiation is initiated on the basis of coding modes initially selected independently for each of the mobiles (as in the example of the method shown in FIG. 1), if the coding mode selected initially for at least one of the mobiles is an unauthorized coding mode, negotiation is initiated with that unauthorized coding mode replaced, for that mobile, with an authorized coding mode, provided that the authorized coding mode is supported.

In what follows, and by way of example, the unauthorized coding mode is the AMR mode and the authorized coding modes are the EFR, FR and HR modes.

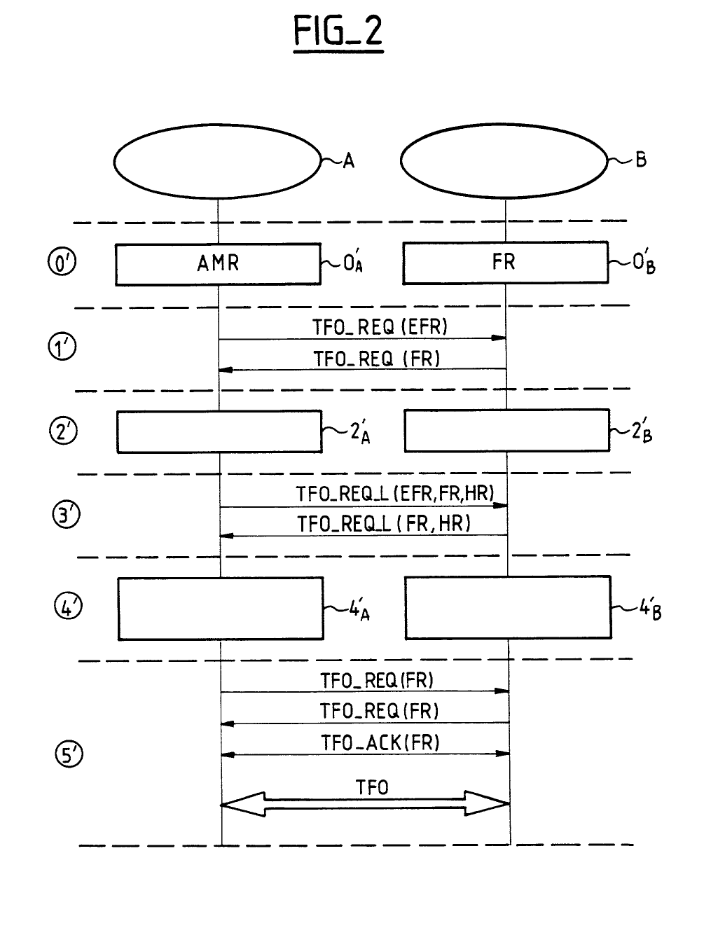

FIGS. 2, 3 and 4 all relate by way of example to the situation in which the coding mode initially selected for the mobile managed by the local entity A is the AMR mode.

In accordance with the invention, and in the examples illustrated by the figures, negotiation is then initiated by replacing for the mobile managed by the local entity A the AMR mode with one of the coding modes that are supported, for example the EFR mode in the examples shown.

FIG. 2 corresponds to the situation in which the coding mode initially selected for the mobile managed by the remote entity B is neither the unauthorized AMR mode nor the authorized coding mode chosen to replace it.

For example, FIG. 2 corresponds to the situation in which the coding mode initially selected for the mobile managed by the remote entity A is the FR mode, as indicated in the initial step 0′(0′_{A}, 0′_{B}) in the figure. Also by way of example, FIG. 2 corresponds to the situation in which the set of coding modes EFR, FR and HR is supported for the mobile managed by the local entity A and the set of coding modes FR and HR is supported for the mobile managed by the remote entity B.

In this example, in FIG. 2, the negotiation includes:

a first signaling step 1′ during which the local entity A transmits a message TFO_REQ (EFR) to the remote entity B and the remote entity B transmits a message TFO_REQ (FR) to the local entity A,

a step 2′ (2′_{A}, 2′_{B}) during which each entity determines that the coding modes on the basis of which the negotiation was initiated do not match,

a second signaling step 3′ during which the local entity A transmits a message TFO_REQ_L (EFR, FR, HR) to the remote entity B and the remote entity B transmits a message TFO_REQ_L (FR, HR) to the local entity A,

a step 4′ (4′_{A}, 4′_{B}) during which it is determined if a coding mode is supported in common in the lists of coding modes supported exchanged in this way in step 3′ (the AMR mode being eliminated from at least one of those lists); in this example, among the coding modes supported in common, because the FR coding mode provides the best speech quality, it constitutes the common coding mode for the TFO mode and a change of coding mode is effected in step 4′_{A}, from the AMR mode to the FR mode, and

a step 5′ during which the local entity transmits a message TFO_REQ (FR) to the remote entity, the remote entity transmits a message TFO_REQ (FR) to the local entity, the local and remote entities exchange messages TFO_ACK (FR) and then the local and remote entities exchange TFO frames.

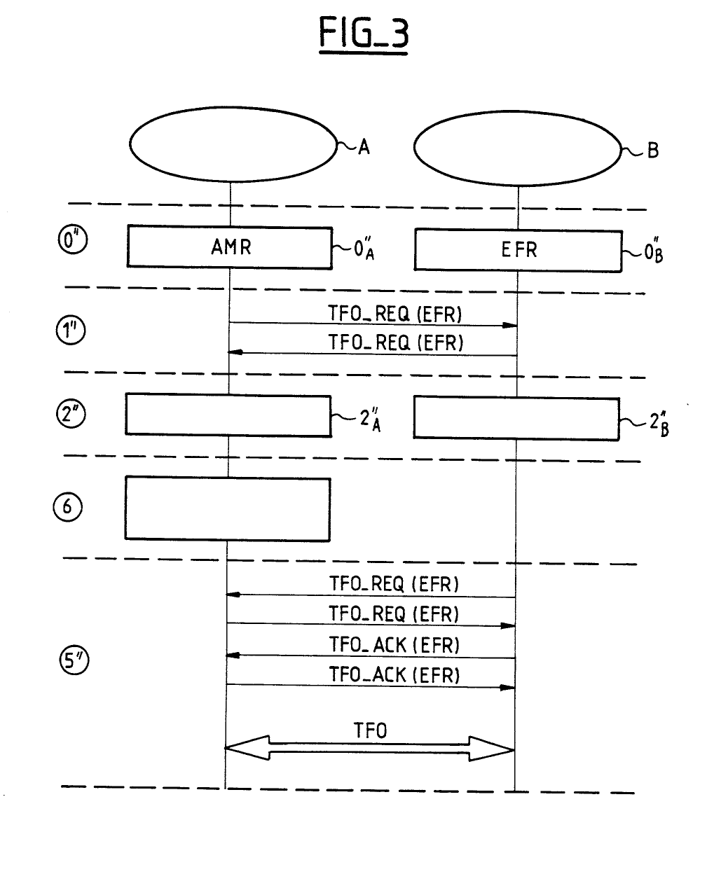

FIG. 3 corresponds to the situation in which the coding mode initially selected for the mobile managed by the remote entity B is the authorized coding mode chosen to replace it (in this example the EFR mode) as indicated in step 0″ (0″_{A}, 0″_{B}) in the figure.

In this example, as shown in FIG. 3, the negotiation includes:

a first signaling step 1″ during which the local entity A transmits a message TFO_REQ (EFR) to the remote entity B and the remote entity B transmits a message TFO_REQ (EFR) to the local entity A,

a step 2″ (2″_{A}, 2″_{B}) during which, although the coding modes on the basis of which the negotiation was initiated match, it is determined in the local entity A that the coding modes initially selected independently for each of the mobiles do not match, although in the remote entity B it is not possible to detect that the coding modes initially selected independently for each of the mobiles do not match,

a step 6 during which a change of coding mode is then effected, for the local entity A, from the AMR mode to the EFR mode chosen to replace it, so that the EFR coding mode then constitutes the common coding mode for the TFO mode, and

a step 5″ during which the local entity A transmits a message TFO_REQ (EFR) to the remote entity B, the remote entity B transmits a message TFO_REQ (EFR) to the local entity A, the local and remote entities exchange messages TFO_ACK (EFR) and then the local and remote entities exchange TFO frames.

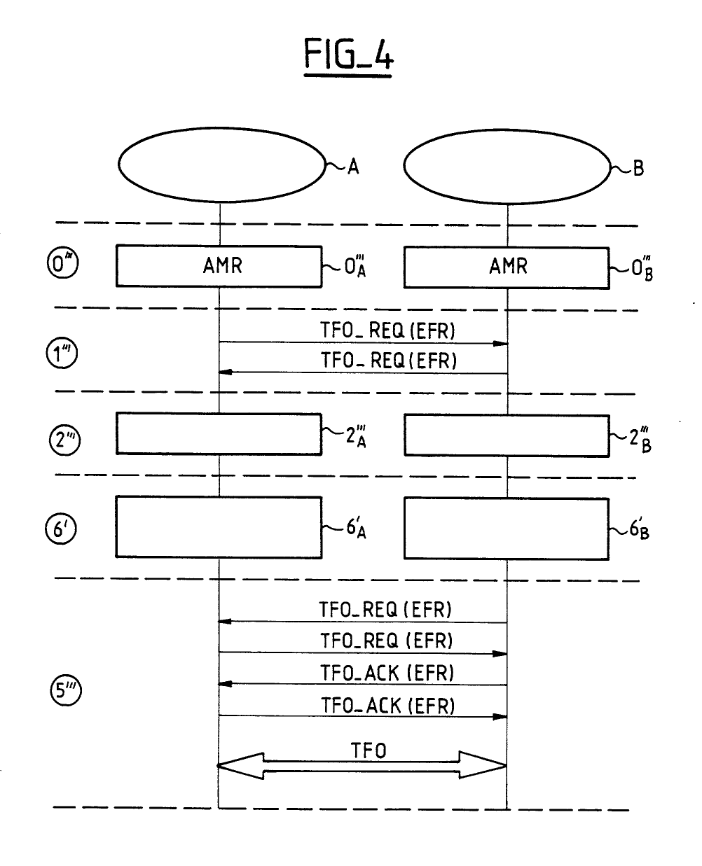

FIG. 4 corresponds to the situation in which the coding mode initially selected for the mobile managed by the remote entity B is the unauthorized AMR mode, as indicated in step 0′″ (0′″_{A}, 0′″_{B}) in the figure.

By way of example, FIG. 4 corresponds to the situation in which the EFR mode chosen to replace the AMR mode is supported for each of the mobiles.

In this example, as shown in FIG. 4, the negotiation includes:

a first signaling step 1′″ during which the local entity A transmits a message TFO_REQ (EFR) to the remote entity B and the remote entity B transmits a message TFO_REQ (EFR) to the local entity A,

a step 2′″ (2′″_{A}, 2′″_{B}) during which, although the coding modes on the basis of which the negotiation was initiated match, it is determined in the local entity A and in the remote entity B that the coding modes initially selected independently for each of the mobiles do not match,

a step 6′ (6′_{A}, 6′_{B}) during which a change of coding mode is then effected for the local entity A and for the remote entity B, from the AMR mode to the EFR mode chosen to replace it, so that the EFR coding mode then constitutes the common coding mode for the TFO mode, and

a step 5″ during which the local entity A transmits a message TFO_REQ (EFR) to the remote entity B, the remote entity B transmits a message TFO_REQ (EFR) to the local entity A, the local and remote entities exchange messages TFO_ACK (EFR) and then the local and remote entities exchange TFO frames.

It will be noted that the figures represent such processes only schematically, to the extent needed to understand the present invention, and without going into the details of the signaling methods or protocols, which can employ standard principles of such systems.

It will further be noted that the figures merely correspond to embodiments and/or to examples of coding modes, and that the embodiments are described by way of illustrative and non-limiting example only, other embodiments being feasible, of course.

It will further be noted that the figures correspond to a particular system, here the GSM, but that the invention is not limited to that example and/or to that system.

In particular:

the AMR coding mode, on the one hand, and the HF, FR and EFR coding modes, on the other hand, merely constitute one example of coding modes that are respectively unauthorized and authorized for the TFO mode, and

although the above description does not consider the situation in which only the coding mode initially selected for the mobile managed by the remote entity is the AMR mode, the present invention also applies to that situation, in which case it is sufficient for the AMR mode to be eliminated from at least one of the lists of coding modes supported in which the common coding mode for the TFO mode is selected.

The present invention also provides, in addition to the above method, a cellular mobile radio system including means for implementing the method.

In the example considered above, the system includes means for implementing the steps previously described.

More generally, the system essentially includes, for optimizing speech quality, in the case of a coding mode that is unauthorized for the tandem free operation mode, means for using in this case, instead of a tandem operation mode, the tandem free operation mode, if possible, with an authorized coding mode, provided that the authorized coding mode is supported.

The particular implementation of such means will not be a problem for the skilled person, and so such means do not need to be described here in more detail than their previous functional description.

There is claimed:

1. A method of optimizing speech quality in a mobile radio system by using if possible a tandem free operation mode for a mobile-to-mobile call, in which method, because said tandem free operation mode is impossible in the case of a coding mode that is unauthorized for that operation mode, instead of using a tandem operation mode in this case, said tandem free operation mode is used, if possible, with an authorized coding mode, provided that said authorized coding mode is supported.

2. The method claimed in claim 1, wherein if said tandem free operation mode is established after negotiation with the aim of selecting a common coding mode for that operation mode, and said negotiation was initiated on the basis of coding modes initially selected independently for each of said mobiles, and if said coding mode initially selected for at least one of said mobiles is an unauthorized coding mode, negotiation is initiated with said unauthorized coding mode for that mobile replaced by an authorized coding mode, provided that said authorized coding mode is supported.

3. The method claimed in claim 1, wherein if said coding modes on the basis of which said negotiation was initiated match they constitute said common coding mode for said tandem free operation mode.

4. The method claimed in claim 1, wherein if said coding modes on the basis of which said negotiation was initiated do not match a common coding mode for said tandem free operation mode is selected on the basis of lists of coding modes supported, for each of said mobiles, at least one of said lists not including any unauthorized coding mode.

5. The method claimed in claim 1, wherein said system is the GSM.

6. The method claimed in claim 1, wherein one unauthorized coding mode is an adaptive coding mode.

7. The method claimed in claim 6, wherein one adaptive coding mode is the AMR mode.

8. The method claimed in claim 1, wherein one authorized coding mode is the full rate mode.

9. The method claimed in claim 1, wherein one authorized coding mode is the enhanced full rate mode.

10. The method claimed in claim 1, wherein one authorized coding mode is the half rate mode.

11. A mobile radio system for implementing a method of optimizing speech quality in a mobile radio system by using if possible a tandem free operation mode for a mobile-to-mobile call, in which method, because said tandem free operation mode is impossible in the case of a coding mode that is unauthorized for that operation mode, instead of using a tandem operating mode in this case, said tandem free operation mode is used, if possible, with an authorized coding mode, provided that said authorized coding mode is supported, in which system a tandem free operation mode is used if possible for a mobile-to-mobile call, and, if said tandem free operation mode is not possible in the case of a coding mode that is unauthorized for that operation mode, it includes means for, instead of using a tandem operation mode in this case, using said tandem free operation mode, if possible, with an authorized coding mode, provided that said authorized coding mode is supported.

12. The system claimed in claim 11, wherein if said tandem free operation mode is established after negotiation with the aim of selecting a common coding mode for that operation mode, if said negotiation was initiated on the basis of coding modes initially selected independently for each of said mobiles, and if said coding mode initially selected for at least one of said mobiles is an unauthorized coding mode, negotiation is initiated with said unauthorized coding mode for that mobile replaced by an authorized coding mode, provided that said authorized coding mode is supported.

13. The system claimed in claim 11, wherein if said coding modes on the basis of which said negotiation was initiated match they constitute said common coding mode for said tandem free operation mode.

14. The system claimed in claim 11, wherein if said coding modes on the basis of which said negotiation was initiated do not match a common coding mode for said tandem free operation mode is selected on the basis of lists of coding modes supported, for each of said mobiles, at least one of said lists not including any unauthorized coding mode.

15. The system claimed in claim 11, wherein said system is the GSM.

16. The system claimed in claim 11, wherein one unauthorized coding mode is an adaptive coding mode.

17. The system claimed in claim 16, wherein one adaptive coding mode is the AMR mode.

18. The system claimed in claim 11, wherein one authorized coding mode is the full rate mode.

19. The system claimed in claim 11, wherein one authorized coding mode is the enhanced full rate mode.

10. The method claimed in claim 1, wherein one authorized coding mode is the half rate mode.
